(19) United States
(12) Patent Application Publication
(10) Pub. No.: US 2016/0114280 A1
(43) Pub. Date: Apr. 28, 2016

(54) Filter Assembly for a Fluid-Permeable Substrate

(71) Applicant: Air Filtration Products, Inc., Oklahoma City, OK (US)

(72) Inventor: Brian Dunaway, Oklahoma City, OK (US)

(73) Assignee: Air Filtration Products, Inc.

(21) Appl. No.: 14/925,728

(22) Filed: Oct. 28, 2015

Related U.S. Application Data
(60) Provisional application No. 62/069,670, filed on Oct. 28, 2014.

(51) Int. Cl. B01D 46/10; B01D 46/42; A62B 23/02; B01D 46/00

(52) U.S. Cl. CPC B01D 46/10; B01D 46/0015; B01D 46/4227; A62B 23/025

(57) ABSTRACT

Apparatus and method for filtering contaminants from a fluidic flow. In some embodiments, a filter assembly includes a filter media comprising a fluid-permeable material, and an array of spaced-apart adhesive dots applied to a selected surface of the filter media configured to secure the filter media to a fluid-permeable substrate.

### RELATED APPLICATIONS

The present application makes a claim of domestic priority to U.S. Provisional Patent Application Ser. No. 62/069,670 filed Oct. 28, 2014, the contents of which are hereby incorporated by reference.

### BACKGROUND

Directed airflow is generated and used in a variety of operational environments, such as for the purpose of providing thermal cooling. Examples of equipment and systems that use directed airflow include, but are not limited to, electronic devices (e.g., computers, televisions, gaming consoles, etc.), residential, commercial and industrial HVAC (heating, ventilation and air conditioning) systems, refrigeration systems (freezers, refrigerators, etc.), mechanical machinery, engines, storage vessels and clean rooms.

These and other systems may use a fan or other pressure source to generate a volume of relatively high or relatively low pressure. The generated pressure differential causes atmospheric air (or other fluid) to be directed to a system component at a location of interest. Ducts, vents, plenums, diverters, grates and other types of conduit mechanisms can be used to channel the directed airflow from (or to) the pressure source.

The operational efficiency of these and other types of systems can be adversely affected by contaminants. Contaminants can take a variety of forms such as dust, dirt, mold spores, ash, smoke, hydrocarbons, mites, allergens, organic material and other particulates. The presence of contaminants can directly affect system component performance should the contaminants aggregate on or near the components. Contaminants can also indirectly affect system component performance by, for example, restricting cooling airflow that passes adjacent the components so that less than optimum thermal exchange is obtained between the components and the airflow.

Depending upon the environment, one or more filters are often placed along an airflow (fluidic) path to restrict the passage of airborne contaminants through a system. A number of filter configurations have been proposed in the art. While operable, one limitation with many existing filter configurations is a change in operational performance over time.

When initially installed (or cleaned), many existing filters provide an acceptable level of filtering performance. Over time, however, both the filter efficiency and throughput can become degraded with the accumulation of contaminants within the filter. Such problems are compounded in environments where, traditionally, no filters are utilized, and in environments where existing filters are utilized but are subjected to relatively large contaminant loading.

SUMMARY

Various embodiments of the present disclosure are generally directed to an apparatus and method for filtering contaminants from a fluidic flow.

In some embodiments, a filter assembly includes a filter media comprising a fluid-permeable material, and an array of spaced-apart adhesive dots applied to a selected surface of the filter media configured to secure the filter media to a fluid-permeable substrate.

### BRIEF DESCRIPTION OF DRAWINGS

FIG. 1 is a simplified functional block representation of a directed air cooling system to provide an illustrative environment in which various embodiments of the present invention may be advantageously practiced.

FIG. 2 is a plan view representation of a filter assembly suitable for use in the system of FIG. 1.

FIG. 3 is a side-elevational schematic representation of the filter assembly of FIG. 2 installed in the system of FIG. 1.

FIG. 4 is a louvered inlet cover.

FIGS. 5A-5C show different configurations of the filter assembly of FIG. 2 in conjunction with the louvered inlet cover of FIG. 4.

FIG. 6 depicts a mesh (screen) inlet cover suitable for use with the filter assembly of FIG. 2.

FIG. 7 depicts a series of cooling fins suitable for use with the filter assembly of FIG. 2.

FIG. 8 is a schematic processing diagram illustrative of steps that may be carried out to form the filter assembly in accordance with some embodiments.

FIGS. 9A-9G depict different adhesive dot patterns suitable for use in another filter assembly similar to the filter assembly of FIG. 2.

FIG. 10 illustrates a laptop computer to show another environment in which various embodiments can be advantageously practiced.

FIGS. 11A-11B show a bottom surface of the laptop computer of FIG. 10 with different applications of the filter assembly of FIG. 2 in some embodiments.

FIG. 12 is a desktop computer to illustrate another show another environment in which various embodiments can be advantageously practiced.

FIG. 13 shows the filter assembly configured for use as a filtering face mask for a human face.

FIG. 14 shows a filter assembly dispenser in accordance with some embodiments.

### DETAILED DESCRIPTION

Without limitation, the present disclosure is generally directed to the filtering of contaminants from a directed airflow. Various embodiments set forth in the present disclosure provide a filter assembly in which a standard media adhesive is applied to a filter material employing any one of such patterns as swirls, dots and speckle dots that are spaced to allow air flow passing through the filter assembly.

As explained below, various embodiments are generally directed to a filter assembly. A filter media layer comprises a permeable, sheet-like flexible layer of woven or nonwoven material. In one embodiment, an array of adhesive dots is applied to a selected surface of the filter media layer. The dots are for the purpose of attachment of the filter assembly to a fluid-permeable substrate of a system through which a directed airflow passes. A cover or backing layer can be applied to the adhesive dots to protect the dots prior to application.

To install the filter assembly, filter assembly is cut or otherwise shaped so that the filter media layer has a desired length and width. The cover layer is removed to expose the array of adhesive dots, and the filter media is positioned on the substrate so that the adhesive dots affix the filter media thereto.

As mentioned above, a variety of filter media, adhesives and dot arrangements can be used depending on the requirements of a given application, as explained herein below. The filter assembly can be applied in any number of different environments.

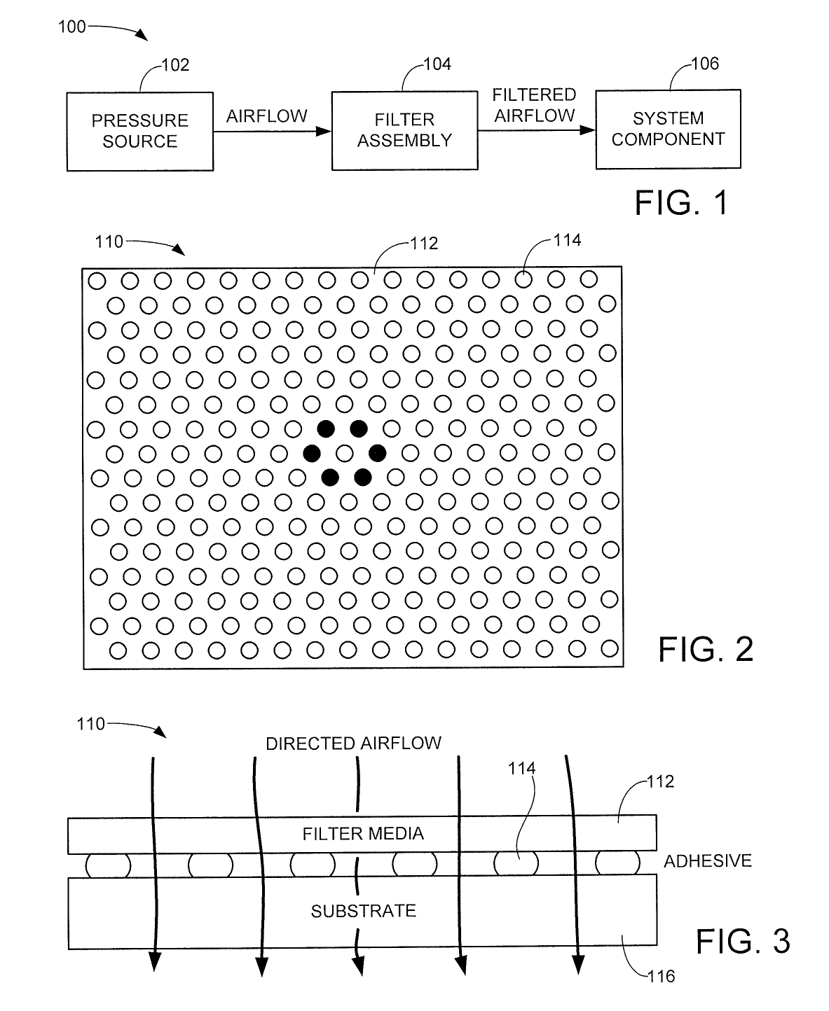

These and other features and advantages of various embodiments can be understood beginning with a review of FIG. 1 which is a simplified functional block representation of a directed airflow system 100. The system 100 is presented to illustrate an example environment in which various embodiments of the present disclosure can be advantageously practiced.

The system 100 includes a pressure source 102, a filter assembly 104 and a system component 106. Other system arrangements can be used, as FIG. 1 is merely exemplary and is not limiting. The pressure source 102 can be a fan or other mechanism that generates an air flow through a differential pressure. A positive pressure is presented to the filter assembly 104 is depicted in FIG. 1, but it will be appreciated that a negative pressure can be generated as desired.

The airflow is directed through the filter assembly 104, which filters airborne contaminants therefrom to provide a filtered airflow which is directed adjacent the system component 106. The filtered airflow may be provided for substantially any suitable purpose. It is contemplated that the airflow in FIG. 1 is to provide cooling for the system cornponent 106. The system component 106 can take any suitable form including but not limited to an electrical component, a mechanical component, a heat exchanger, refrigeration system, an airflow inlet, etc.

It should be understood that, while FIG. 1 depicts the use of “air,” various embodiments can be used for any number of different types of atmospheric (gas) environments, such as an inert environment (e.g., helium), a purified oxygen environment, a clean room environment, etc.

FIG. 2 is a plan view representation of a filter assembly 110 constructed and operated in accordance with various embodiments of the present disclosure. The filter assembly 110 is suitable for use in the system 100 of FIG. 1. In some cases, the filter assembly 104 of FIG. 1 comprises an existing filter (e.g., paper filter, HEPA filter, etc.) and the filter assembly 110 of FIG. 2 is used in conjunction therewith. In other cases, the filter assembly 110 can constitute the filter assembly 104.

The filter assembly 110 includes a layer of filter media 112, and an array of adhesive dots 114 that are affixed to the filter media layer. The filter media 112 can take a variety of forms, but generally comprises a thin, flexible paper-like sheet of permeable material. The filter media can be a woven or non-woven material.

Without limitation, in one embodiment the filter media is formed of polyester ( polyethylene terephthalate) having a weight of about 1.5 ounces per square yard (oz/yd²), a thickness of about 11.0 mils (0.011 inches), an air porosity of about 438 cubic feet per minute (cfm), and a Mullen burst rating of about 37.8 pounds per square inch (psi). Other configurations can be used including, but not limited to, polyester blends, rayon (regenerated cellulose fibers), rayon blends, etc.

The adhesive dots 114 are formed from a suitable adhesive material having sufficient binding properties so as to resist separation once the filter media is installed. Adhesives used to form the dots 114 can include any number of glues, pastes, gels, or other materials. Without limitation, in one embodiment the adhesive is a silicon-based thermally and/or electrically conductive gel.

The dots 114 can take many suitable shapes, such as the hemispherically shaped dots depicted in FIG. 2; but other forms including elongated, curvilinear, rectilinear, etc. shapes can be applied. It will be noted that the dots are arranged in spaced-apart fashion to facilitate airflow passage between adjacent adhesive dots in the array, or matrix. A regularly occurring (periodic) hexagonal arrangement is depicted in FIG. 2, as represented by the dots shown in black, with six adjacent dots surrounding a central dot and airflow directed between each pair of the adjacent dots. Other arrangements, including non-periodic arrangements, are contemplated and will be discussed below. The relative sizes of the dots with respect to the spacings therebetween can vary, so that larger or smaller dots than those shown can be used.

FIG. 3 is a schematic depiction of the filter assembly 110 of FIG. 2 attached to a permeable substrate 116. The substrate 116 can take any number of forms, and suitable examples will be discussed in detail below. At this point it will be appreciated that the adhesive dots 114 serve to affix the filter media 112 to the substrate, so that a directed airflow, as depicted in FIG. 1, passes through the filter media 112, between adjacent pairs of the dots 114, and through the substrate 116. The direction of airflow is not necessarily important; in an alternative embodiment, the same arrangement of FIG. 3 can be provided with the airflow passing through the substrate 116 prior to passing through the filter media 112. Generally though, the orientation of FIG. 3 exposes a larger surface area of the filter medium 112 to the inlet airflow to accumulate contaminants.

It will be appreciated that FIG. 3 is merely representational in nature and is not drawn to scale. The particular shape, sizes and relative thicknesses of the adhesive dots 114 relative to the filter media 112 and the substrate 116 can vary.

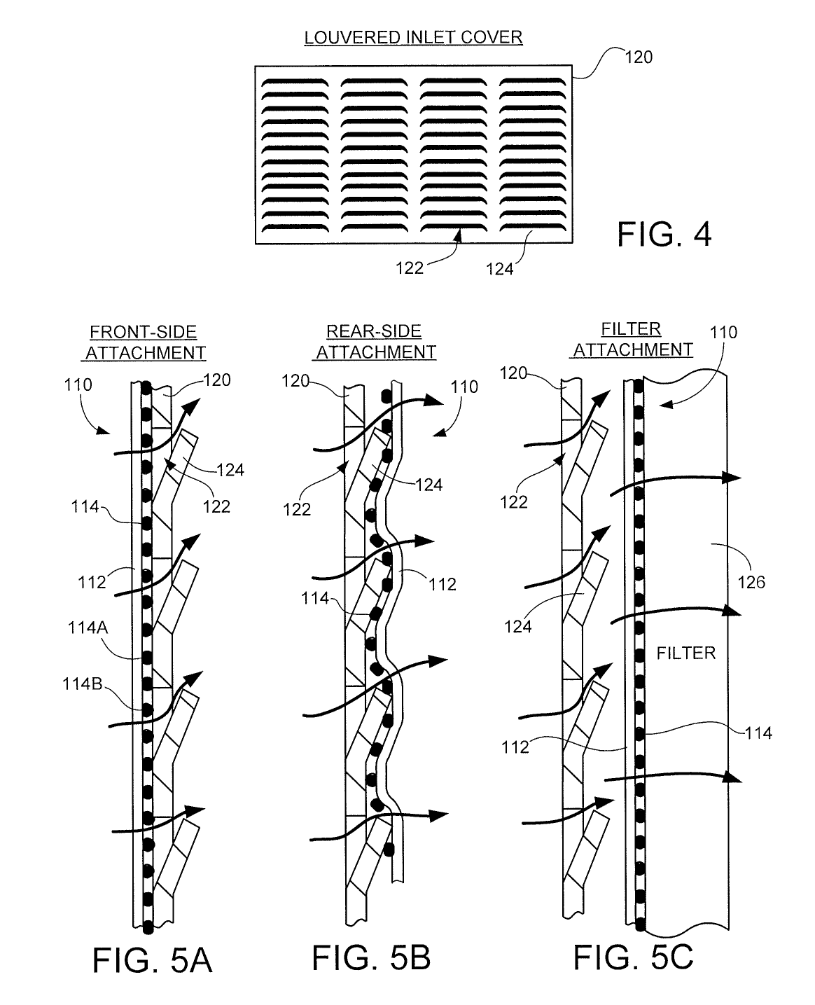

FIG. 4 depicts a louvered inlet cover 120 with a number of pass-through louvered openings 122, providing one example substrate with which the filter assembly 110 can be used. The cover 120 is normally formed of sheet metal or other suitable planar, rigid material, and the openings 122 formed by cutting and bending elongated tangs (tabs) 124 from the base material. Other forms of covers are readily contemplated.

The cover 120 can be characterized as an inlet cover for an air handling system to cover an inlet return conduit, such as in a residential HVAC system. Alternatively, the cover 120 can represent an inlet plate on the housing of an electronic device or module. Although not shown, a pressure source such as 102 in FIG. 1 may be placed in fluidic communication to draw a directed airflow through the cover 120.

In one embodiment, the filter assembly 110 is attached directly to a front-facing (exterior) surface of the cover 120, as depicted in FIG. 5A. Airflow thus passes through the filter media 112, between the adhesive dots 114 and through the openings 122 formed by the tabs 124 in the cover 120.

The filter assembly 110 is substantially planar in FIG. 5A and conforms to the planar exterior surface of the cover 120. It will be noted that certain adhesive dots, such as 114A, are in locations between adjacent openings 122 and thus contactingly engage the cover 120 to secure the filter media 112 thereto. Other adhesive dots, such as 114B, are located adjacent the openings 122 and do not make contact with the cover 120. It will be noted that the dots such as 114B that do not contact the cover may retain their initial, substantially spheroid shapes while the dots such as 114A that do contact the cover may be deformed.

Even though substantially the entire facing surface of the filter media 112 is covered with the dots 114, there is sufficient space between adjacent dots to permit airflow through the filter media and into the system through the cover 120. Any suitable ratio of coverage can be provided, from about 10% of the total surface area of the filter media 112 being covered by the adhesive dots 114 to about 80% of the total surface area of the filter media 112 covered by the adhesive dots 114. One suitable range has been found to be from about 30% to about 70% coverage. Another suitable range has been found to be from about 40% to about 60% coverage, while yet another suitable range has been found to be about 50% coverage. Of course, other ranges can be used including coverages from about 2% up to about 98%. The use of the term “about” means ±1%. The selected range should provide adequate flowthrough (e.g., cfm) characteristics so that the baseline filter media flow rate is not substantially affected by the application of the adhesive dots.

It is contemplated that a user, provided with the filter assembly 110 in an initial size such as in a sheet or rolled form, would cut the filter assembly 110 to have outermost length and width dimensions that substantially correspond to the outermost length and width dimensions of the cover 120. The presence of the adhesive dots 114 across substantially the entirety of the cut dimensions of the filter media 112 ensure that no gap will occur at the edges of the installed filter assembly. That is, all of the openings 122 (FIG. 4) are covered by the filter media.

FIG. 5B illustrates another attachment option using the filter assembly 110 and the cover 120. In FIG. 5B, the filter assembly 110 is attached to the interior surface of the cover 120. Due to the inwardly projecting tabs 124, the interior surface of the cover 120 is contoured rather than planar as is the case of FIG. 5A. The flexible nature of the filter assembly 110 allows the assembly to be easily conformed to this contoured surface. While not shown, in an alternative embodiment the filter assembly 110 can be stretched so as to be substantially planar as in FIG. 5A, and provide contact against only a small portion of the contoured surface of the cover, such as the distal ends of the tabs 124.

As before, some but not all of the abrasive dots in FIG. 5B will contact the cover 120. The directed airflow will pass through the openings 122, between the abrasive dots 114 and through the filter media 112 to provide a flow of filtered air.

FIG. 5C shows yet another embodiment in which an interior filter 126, such as a corrugated paper filter, is supported behind the cover 120. In this case, the filter assembly 110 can be attached directly to a surface of the filter 126 instead of to the cover 120. The attachment may occur against filter media of the filter 126, or against structural aspects (e.g., a cardboard or metal frame, etc.) of the filter 126. The filter assembly 110 can be used in conjunction with the filter 126 as in FIG. 5C, or can be used instead of the filter 126 so that the filter 126 can be eliminated.

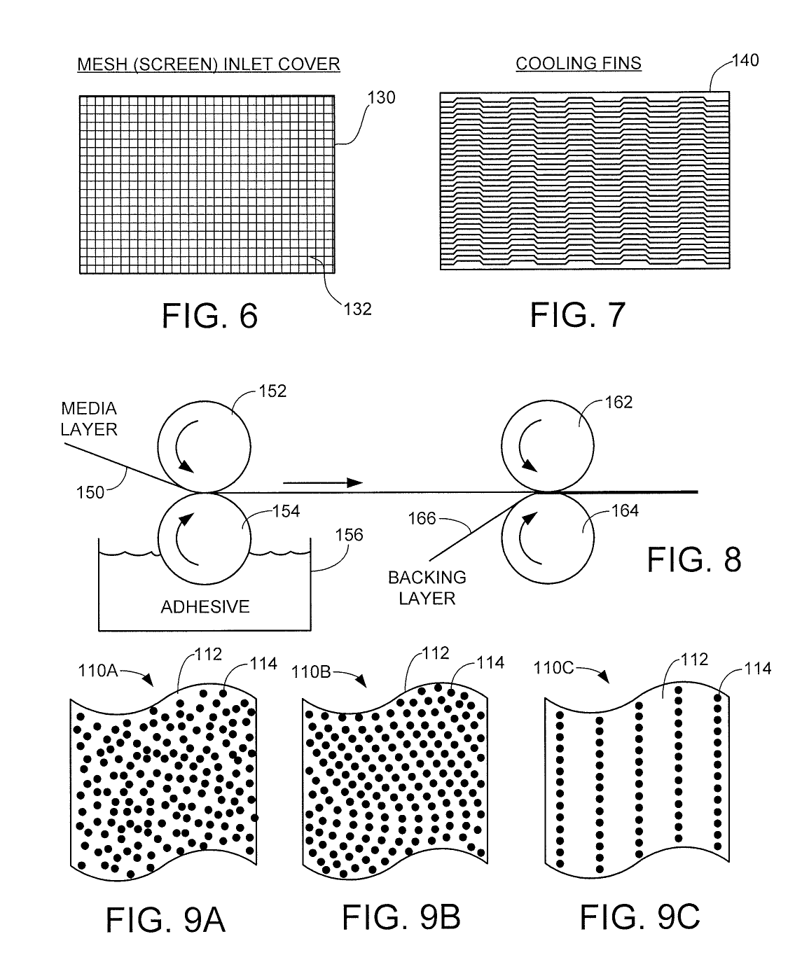

FIG. 6 shows another fluid permeable cover member 130 to which the filter assembly 110 can be attached. The cover member 130 is characterized as a mesh (screen) inlet cover with a series of relatively thin, elongated support filaments 132 extending in a crosshatched fashion. The array of adhesive dots 114 can contactingly engage an interior or exterior surface of the mesh to secure the filter media.

FIG. 7 depicts an arrangement of cooling fins 140 of a system, such as a refrigeration system. The cooling fins may be formed of corrugated metal or other material and are arranged to radiate heat as a heat exchanger. The filter assembly 110 can be affixed directly to the cooling fins 140, thereby filtering contaminants without restricting airflow to the system. It will be appreciated that attachment of the filter assembly 110 may significantly reduce maintenance service for the cooling fins 140, since the filter assembly substantially prevents ingress of deleterious contaminants.

In each of the foregoing examples, the filter assembly 110 can be easily and quickly installed, applied for a suitable service life interval, and then easily and quickly removed and replaced with a new replacement filter. Substantially no adhesive residue is left when the filter assembly 110 is peeled off of an existing substrate surface, and a replacement filter assembly can be installed in a very short period of time. Filter assemblies, such as the filter assembly110, can significantly reduce the time and service costs for a large number of different types of applications.

FIG. 8 is a schematic depiction of a manufacturing process that can be applied to form the filter assembly 110 or any such filter assembly discussed herein. A media layer 150 in the form of a continuous web is directed between a first set of opposing rollers 152, 154; the lower roller 154 contacts an adhesive bath 156 to draw up a thin layer of adhesive that is transferred to the lower surface of the web 150. As desired, the roller 154 may be texturized with a selected pattern so that, upon contact with the web, the desired pattern of adhesive is transferred to the web.

The web (media layer 150) is directed to a second set of opposing rollers 162, 164, where a backing layer 166 is affixed to the web 150 and the adhesive thereon. The backing layer 166 can take the form of a thin layer of wax paper, silicone or other suitable material to cover the adhesive ready for installation to the filter. The backing layer 166 is designed to be easily peeled from the adhesive while not causing the adhesive dots to lift off of the media layer 150. Any number of alternative arrangements can be carried out to manufacture the filter assembly 110.

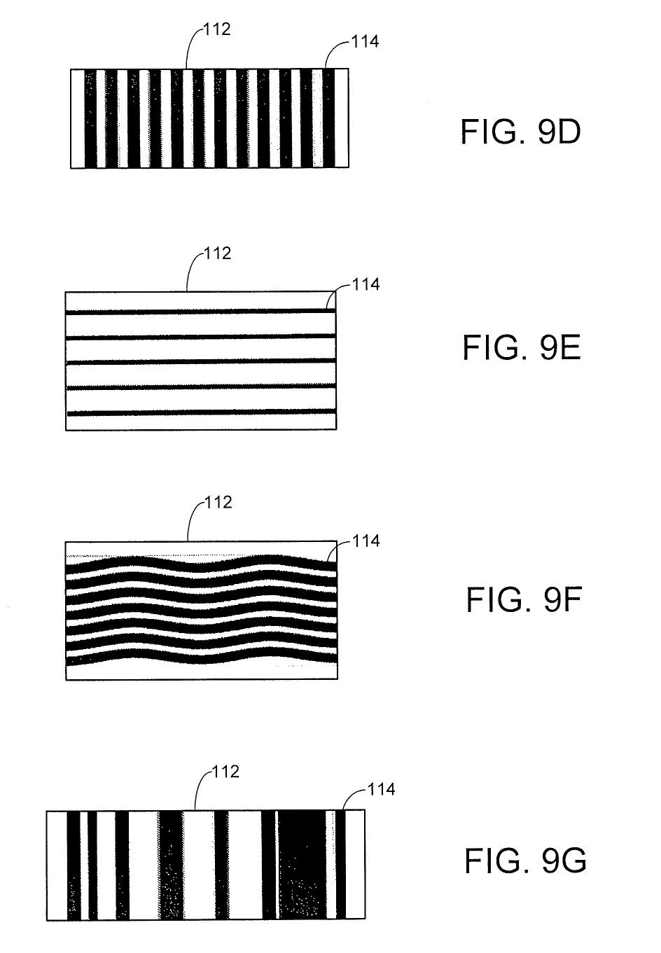

FIGS. 9A-9G show respective filter assemblies 110Athrough 110G. In each case, the filter assemblies include the aforementioned filter media layer 112 and abrasive dots 114 in the different dot arrangements depicted therein.

The filter assembly 110A in FIG. 9A uses a non-periodic (random) arrangement of the adhesive dots 114. The filter assembly 110B in FIG. 9B uses a repeating swirl pattern. The filter assembly 110C in FIG. 9C uses spaced apart rows that extend in a selected direction (in this case, a vertical direction).

The filter assembly 110D in FIG. 9D shows the adhesive dots in wide bands. The dots can be spaced apart or essentially contiguous. Solid bands of adhesive can be provided or relatively small spacings can be provided between adjacent dots. FIG. 9E shows the adhesive dots as a series of narrower horizontal bands. As before, the adhesive can be contiguous or formed of spaced apart elements. FIG. 9F provides wavy bands of dots. Each band can be a single contiguous dot or formed of individual, closely spaced dots. A wavy pattern can facilitate attachment to different features of the adjacent substrate. FIG. 9G shows an irregular pattern of bands extending in a selected direction (in this case, vertical but such is not required). The bands are made up of contiguous or individual, closely spaced dots.

Any number of other patterns and forms of the dots can be used depending on the requirements of a given application, including patterns that mix and match various patterns in different locations of the substrate 112. In further embodiments, a picture frame arrangement can be provided so that the dots 114 are arranged near a perimeter of the substrate 112 and medial portions of the substrate have a lower density of dots (either no dots or fewer dots). The dots arranged along the perimeter of the substrate can be arranged as a continuous strip of adhesive or an arrangement of individual dots, as required.

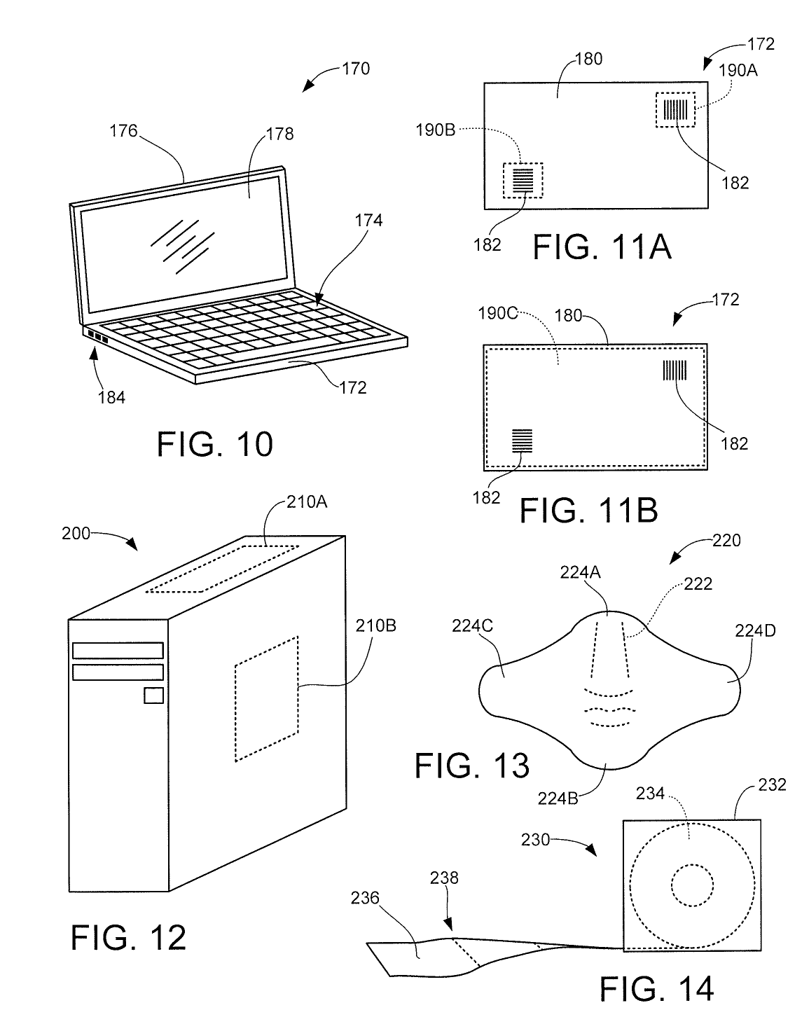

FIG. 10 illustrates a laptop computer 170 showing another environment in which the various embodiment filter assemblies disclosed herein can be advantageously practiced. The laptop computer 170 includes a rigid base 172 with a keyboard 174 and/or other user interface mechanisms (e.g., track ball, touch pad, etc.). A cover 176 is hinged to the base 172 and includes a display screen 178 to provide a visual interface with the user. Housed within the base 172 and/or cover 176 are one or more electronic modules including processors, memory, control boards, switching devices, solid-state drives (SSDs), hard disc drives (HDDs), optical drives, fans, etc.

These and other electronic modules within the laptop computer 170 consume electrical power and can require a cooling air flow to relieve the generation of heat by the electronic modules. As shown by FIGS. 11A-11B, a bottom surface 180 of the base 172 can include a number of fluid permeable vent apertures (inlet covers) 182 that facilitate the ingress of cooling air into the housing of the computer 170. The particular number, arrangement and location(s) of the vent apertures 182 can vary depending on the configuration of the computer. A separate exit vent 184 can be used to allow warmed air drawn through the vent apertures 182 to exit the housing, as depicted in FIG. 10. As before, the exit vent 184 can be in any suitable location, including along bottom surface 180.

In FIG. 11A, localized, individual filter assemblies 190A, 190B are cut to size and adhered to the bottom surface 180 to span and filter the air passage into the vent apertures 182. In FIG. 11B, a single filter assembly 190C is cut to size and adhered to the bottom surface 180 to span substantially the entirety of the bottom surface 180, thus covering the vent apertures 182. Covering the entire bottom surface 180 as in FIG. 11 B also may provide other advantages, such as producing a cushioned, low-skid surface for the laptop computer 170.

FIG. 12 depicts a desktop computer 200 having a tower configuration. Filter assemblies 210A, 210B are affixed to various inlet vent apertures to filter inlet air flow as described above. It will be appreciated that similar applications can be made with any number of different types of electronic modules including other personal computer configurations, smart phones, tablets, home theatre components, gaming consoles, kitchen appliances, powered tools, etc.

FIG. 13 shows another filter assembly 220 in accordance with some embodiments. The filter assembly 220 takes the form of a temporary surgical-type mask adapted to be adhered in a sealing fashion against a human face (depicted generally at 222) to cover the nose and mouth of the user. One possible shape of the mask material is depicted in FIG. 13, with respective projections (tangs) 224A, 224B, 224C and 224D. Upper tang 224A sealingly affixes to the bridge of the user's nose; lower tang 224B sealingly affixes to the user's chin; and left and right tangs 224C, 224D respectively sealingly adhere to the user's cheeks. One envisioned use of the filter assembly configuration of FIG. 13 is the use of the filter assembly 220 as a disposable, easily field deployable contaminant mask for emergency personnel.

FIG. 14 is a schematic representation of a filter assembly dispenser mechanism 230 in further embodiments. The mechanism 230 includes a housing 232 which encloses a roll 234 of the filter assembly for use as needed. The filter assembly is dispensed from the housing through an egress port (not separately designated) as a sequence of partitions 236 separated by perforations 238. The perforations are pre-cut holes to allow the user to easily tear and individually separate the partitions as required.

Each partition 236 can be of a suitable size, such as nominal length and width dimensions of about 2 inches, in. by about 1 in. Other sizes can be used. In an alternative embodiment, a cutting mechanism (not separately shown) can be provided at the egress port to allow strips of the filter assembly to be dispensed and cut to the desired length. As before, the filter assembly partitions 236 each include a layer of filter media, a matrix of adhesive dots, and a backing layer. The backing layer can be peeled off for application of the partition to a suitable fluid permeable surface.

Any suitable ingress or egress fluidic-flow location can be covered by the material set forth in the present disclosure, including gas inlet or outlet ports on armaments (projectile weapons such as the so-called M4 and M16 assault weapons). It has been found, for example, that the filter material as disclosed herein can be used to provide a contaminant barrier to the gas ports on certain military weapons and provide enhanced reliability during field operation.

The filtration assembly of the present invention is designed to remove contaminants, such as dust particles, from air in order to extend the functional lifetime of sensitive electronic devices and other appliances, components and mechanisms. The filtration media attaches via an adhesive backing, which is produced by laminating techniques permitting sufficient air flow to maintain adequate function while maximizing protection from airborne contaminants. This air filtration device can be used in a variety of markets including but not limited to commercial, residential, industrial, medical and military markets. The filter can prevent contaminants from damaging computer components due to overheating from lack of heat exchange and enhance energy efficiency of mechanical devices that are dust-sensitive. This product is unique since it can be easily applied and replaced as conditions dictate, allowing users flexibility in protecting their devices regardless of the severity of the environment.

Equipment with parts that can be adversely affected by accumulation of environmental contaminants will have their operational life extended, repair costs reduced, and energy costs minimized. Examples of equipment that can be affected include electronic devices with electronic computer-type boards, e.g., computers, printers, TVs, DVDs, and stereo components. Other examples are mechanical components needing protection from contaminants in the air. The disclosed filter assembly can provide maximum protection from most filterable environmental contaminants while permitting sufficient flow of filtered air to permit normal device or equipment function and prevent overheating. Another powerful advantage is the ease of applying and changing the filter assembly.

A number of applications of the filter assembly are contemplated and will occur to the skilled artisan in view of the present disclosure. Medical applications include the use of the filter assemblies as bandages, surgical masks, etc. A vacuum cleaner such as a shop vac can be lined with one or more layers of the filter assemblies to provide filtering of contaminants in lieu of, or in addition to, a vacuum bag. Weapons such as semiautomatic or automatic rifles can have gas intake inlets covered with the filter assemblies to reduce the ingress of sand, dirt or other battle field debris.

It will be appreciated that the various embodiments presented herein can provide a number of benefits over the existing filter art. The filter assembly as variously embodied herein can be installed in a large number of different environments, including environments not normally adapted for the use of a filter. The filter assembly can be attached directly to an existing permeable substrate, with a portion of the dots contactingly engaging non-permeable portions of the substrate and another portion of the dots spanning in non-contacting relation openings in the substrate. Even though the adhesive should be sufficient to maintain attachment of the filter substrate over the appropriate passageway, additional layers of attachment, such as bands, adhesive strips, attachment plates, etc. can further be used at locations peripheral to the passageway to further secure the media.

It will be clear that the various embodiments presented herein are well adapted to attain the ends and advantages mentioned as well as those inherent therein. While presently preferred embodiments have been described for purposes of this disclosure, numerous changes may be made that will readily suggest themselves to those skilled in the art and that are encompassed in the spirit of the subject matter disclosed and as defined in the appended claims.

What is claimed is:

1. A filter assembly, comprising:
a filter media comprising a fluid-permeable material; and
an array of spaced-apart adhesive dots applied to a selected surface of the filter media configured to secure the filter media to a fluid-permeable substrate.

2. The filter assembly of claim 1, wherein the filter media comprises a layer of polyester.

3. The filter assembly of claim 1, wherein the adhesive dots comprise silicon based thermally conductive silicone gel.

4. The filter assembly of claim 1, wherein the array of adhesive dots is arranged in a periodic pattern.

5. The filter assembly of claim 1, wherein the array of adhesive dots is arranged in a non-periodic pattern.

6. The filter assembly of claim 1, in combination with a fluid-permeable substrate to which the filter media layer is attached by the adhesive dots, the substrate comprising at least one fluid pass-through opening, the adhesive dots comprising a first portion that contactingly engage the substrate and a second portion that span the at least one fluid pass-through opening.

7. The filter assembly of claim 6, wherein the fluid-permeable substrate is an inlet cover that spans a fluidic passageway of a heating, ventilation and air conditioning (HVAC) system.

8. The filter assembly of claim 1, wherein the substrate comprises a plurality of cooling fins of a refrigeration unit.

9. The filter assembly of claim 1, wherein the substrate is an inlet cover of an electronics module.

10. The filter assembly of claim 1, wherein the substrate is a human face.

11. The filter assembly of claim 1, wherein the substrate is a gas inlet and/or outlet port of a weapon.

12. The filter assembly of claim 1, arranged in a dispenser which dispenses the filter assembly from a roll in a dispenser housing.

13. A filter assembly, comprising:
a permeable fluid filter media;
adhesive applied to the filter media in a spaced apart pattern so that fluid is passable through and filtered by the filter media between the adhesive application, the filter media adapted to be secured to a permeable substrate.

14. The filter assembly of claim 13 wherein the adhesive is applied as an array of adhesive dots.

15. The filter assembly of claim 13, wherein the filter media comprises a layer of polyester.

16. The filter assembly of claim 13, wherein the adhesive is arranged as dots comprising silicon based thermally conductive silicone gel.

17. A method comprising:
providing a filter assembly comprising a fluid-permeable substrate material to which is attached an array of spaced-apart adhesive dots; and
attaching the filter assembly to a fluid-permeable substrate using the array of spaced-apart adhesive dots.

18. The method of claim 17, wherein the filter media comprises a layer of polyester, and the adhesive dots comprise silicon based thermally conductive silicone gel.

19. The method of claim 17, wherein the fluid-permeable substrate comprises an air intake port or outlet port of a heating air conditioning ventilation (HVAC) air handling system of a building.

20. The method of claim 17, wherein the fluid-permeable substrate comprises an air filter.
